(19) United States
(12) Patent Application Publication
(10) Pub. No.: US 2009/0138831 A1
(43) Pub. Date: May 28, 2009

(54) Apparatus and method of determining a user selection in a user interface

(76) Inventors: Thomas E. Gitzinger, Palatine, IL (US); Rachid M. Alameh, Crystal Lake, IL (US); Louis J. Vannatta, Crystal Lake, IL (US)

Correspondence Address: LAW OFFICES OF CHARLES W. BETHARDS, LLP, P.O. BOX 1622, COLLEYVILLE, TX, 76034, US

(21) Appl. No.: 12/321,472

(22) Filed: Jan. 21, 2009

Related U.S. Application Data
(63) Continuation of application No. 10/972,662, filed on Oct. 25, 2004, now abandoned.

(51) Int. Cl. G06F 3/033; G06F 3/041

(52) U.S. Cl. 715/863; 345/173

(57) ABSTRACT

A user interface (210) includes an RC circuit (213). The RC circuit (213) includes a variable capacitance. The variable capacitance is produced by a sensing member (310) in cooperation with a user's finger (311). When a user makes a selection with the user interface (210), the user places a finger (311) in close proximity and in a facing relationship to a section, or discrete surface (320, 322, 324), of the sensing member (310). The discrete surfaces (320, 322, 324) can correspond to keys of a keypad (138) or to directions of a directional button (1030), for example. The time constant of the RC circuit (213) varies according to which discrete surface (320, 322, 324) is determining the capacitance of the RC circuit (213). A controller (118) determines the user's selection based on the time constant of the RC circuit (213).

### RELATED APPLICATIONS

This application is a continuation of and claims priority from a co-pending application by Gitzinger, et al., which was filed on Oct. 25, 2004, is identified by Ser. No. 10/972,662, and is titled APPARATUS AND METHOD OF DETERMINING A USER SELECTION IN A USER INTERFACE.

### FIELD OF THE INVENTION

This invention relates in general to user interfaces and more particularly to user interfaces or selectors having means to determine a user selection.

### BACKGROUND OF THE INVENTION

Currently, a matrix of keys in typical hand-held electronic devices, such as mobile telephones, some PDAs (personal digital assistants) and the like, requires multiple electrical lines to transmit or convey information from the keys to a controller. For example, when a three by four (3×4) matrix of keys is utilized, seven lines typically are required to be routed from the keypad to the controller. In hand-held devices with hinges, such as clamshell-type mobile telephones, it may be required to route these electrical lines through a hinge, which can add complication and cost to the design of the hinge and also the overall device. Further, in implementation of many of today's matrix of keys, includes a plurality of different switches, adding more moving parts for making and breaking electrical contact. These switches further complicate and add cost to the manufacture of the keypad and thus the device.

### BRIEF DESCRIPTION OF THE DRAWINGS

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a simplified, exemplary block diagram showing a communication device;

FIG. 2 is an exemplary schematic diagram showing a user input device;

FIG. 3 is an exemplary schematic diagram showing a sensing member, which forms part of the capacitive sensor of FIG. 2;

FIG. 4 is an exemplary schematic diagram showing a user input device that includes a shield;

FIG. 5 is a flow chart showing a method of determining a user's selection from the user input device of FIG. 3 or FIG. 4;

FIG. 6 is a table of key data, which is used in the method of FIG. 5;

FIG. 7 is a diagrammatic plan view of a keypad of the communication device of FIG. 1;

FIG. 8 is a partial diagrammatic cross sectional view taken along the plane indicated by the line 8-8 in FIG. 7;

FIG. 9 is a partial, diagrammatic cross sectional view taken along the plane indicated by the line 9-9 in FIG. 7;

FIG. 10 is a plan view of a directional user input device;

FIG. 11 is a diagrammatic cross sectional view taken along the plane indicated by the line II-II in FIG. 10;

FIG. 12 is another diagrammatic cross sectional view similar to that of FIG. 11; and

FIG. 13-FIG. 17 are plan views of, respective, alternative exemplary embodiments of directional user input devices.

### DETAILED DESCRIPTION

In overview the present disclosure concerns user interfaces, such as those encountered on various electronic devices such as among others, cellular phones. More particularly various inventive concepts and principles, embodied in an apparatus and method of determining a selection in a user interface, are discussed. The user interface can be used in connection with any of a variety of electronic devices that require user input including but not limited to personal computers, game controllers, wireless and wired communication units, such as remote control devices, portable telephones, cellular handsets, personal digital assistants, or equivalents thereof.

As further discussed below various inventive principles and combinations thereof are advantageously employed to provide a method and apparatus for determining a user selection in a user interface.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, upper and lower and the like are used solely to distinguish one from another entity or action without necessarily requiring or implying any actual such relationship or order between such entities or actions.

The terms “a” or “an” as used herein are defined as one or more than one. The term “plurality” as used herein is defined as two or more than two. The term “another” as used herein is defined as at least a second or more. The terms “including,” “having” and “has” as used herein are defined as comprising (i.e., open language). The term “coupled” as used herein is defined as connected, although not necessarily directly and not necessarily mechanically.

Much of the inventive functionality and inventive principles are best implemented with or in software programs or instructions and integrated circuits (ICs) such as application specific ICs as well as novel physical structures. It is expected that one of ordinary skill, notwithstanding possibly significant effort and many design choices motivated by, for example, available time, current technology, and economic considerations, when guided by the concepts and principles disclosed herein will be readily capable of generating such software instructions, ICs, and physical structures with minimal experimentation. Therefore, in the interest of brevity and minimization of any risk of obscuring the principles and concepts according to the present invention, further discussion of such structures, software and ICs, if any, will be limited to the essentials with respect to the principles and concepts used by the exemplary embodiments.

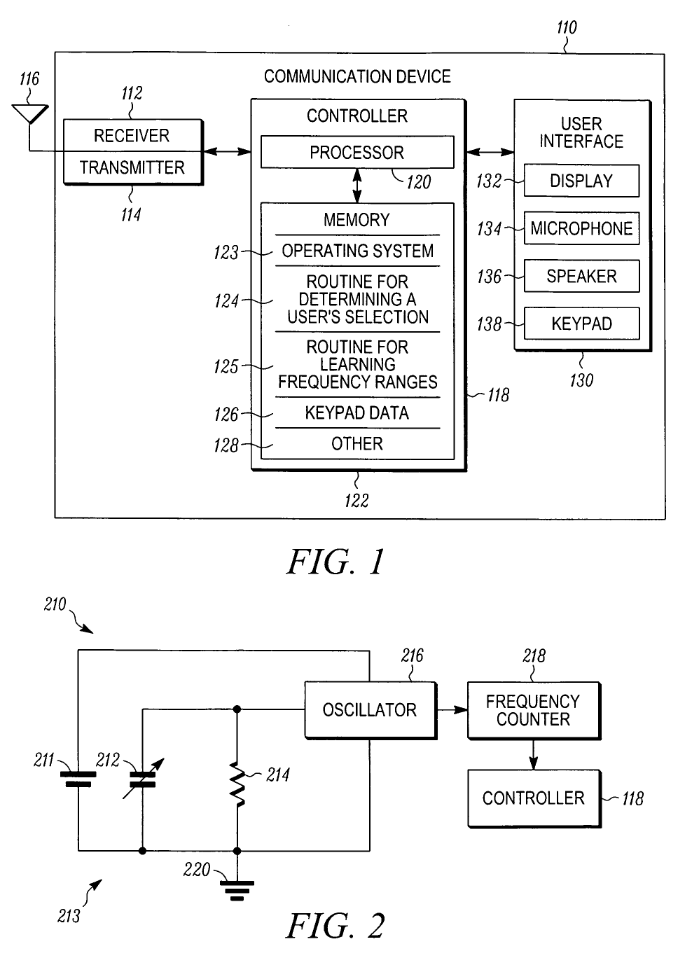

FIG. 1 shows an exemplary electronic device, such as a communication device 110. The communication device 110 can be, for example, a mobile telephone, a personal digital assistant or the like. The communication device 110 includes a receiver 112 and a transmitter 114, which are coupled to an antenna 116. The receiver 112 and the transmitter 114 are conventional and are thus not described in detail.

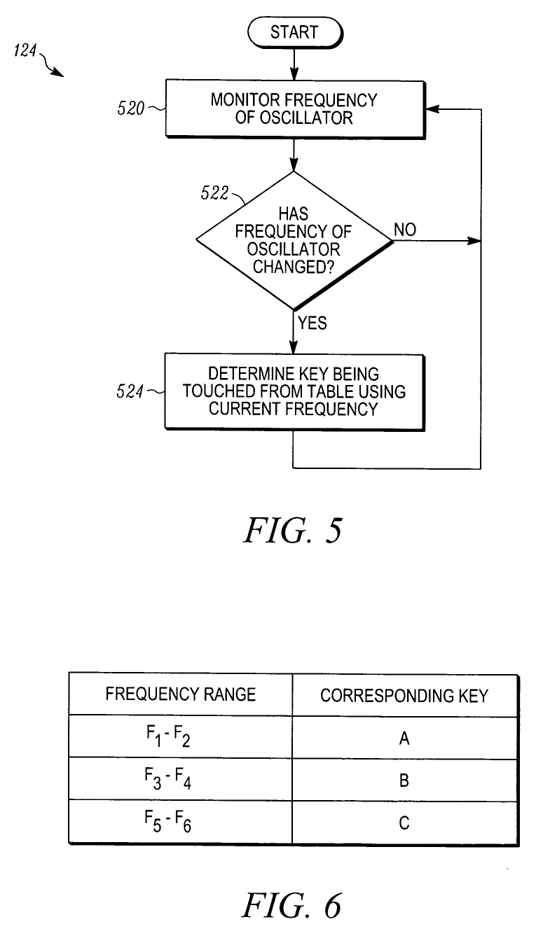

The communication device 110 further includes a controller 118. The controller 118 is coupled to the receiver 112 and transmitter 114 as shown. The controller 118 includes a generally known processor 120 and memory 122, which is coupled to the processor 120 as will be appreciated by those of ordinary skill. The memory 122 stores, for example, software including an operating system 123 including data and variables that is suitable software instructions that when executed by the processor generally control operation of the communication device 110, keypad data 126, which is used for interpreting signals from a keypad 138 (part of a user interface 130), which is discussed below with respect to FIGS. 5 and 6, and other programs and data 128 needed to control the communication device 110. Exemplary routines that can be stored in the memory include a routine for determining a user's selection 124, and a routine for learning frequency ranges that correspond to user selections 125, which are described below.

The user interface 130 is coupled to the controller 118. The user interface 130, for example as illustrated, can include a display 132, a microphone 134, an earpiece or speaker 136, the keypad 138, and the like. The user interface 130 is conventional except for the keypad 138. Thus, only the keypad 138 is described in detail below.

FIG. 2 schematically shows a capacitive user input device 210. The user input device 210 includes a capacitive sensor 212 and a resistor 214, which form an RC circuit 213. The RC circuit 213 further includes a common or ground area 220. Note that resistance is inherent in the RC circuit 213, and the resistor 214 represents the equivalent resistance at the input of an oscillator 216. A battery 211 is located between the oscillator 216 and the ground area 220 and supplies power to the oscillator. The capacitive sensor 212 of FIG. 2 is symbolic of a variable capacitance that is produced by a user and a sensing member. Thus, in FIG. 2, the capacitive sensor 212 is for symbolic and illustrative purposes only.

The RC circuit 213 controls the oscillator 216, i.e. frequency thereof, which is coupled to a frequency counter 218. The frequency counter 218 is coupled to the controller 118. When the capacitance produced by a user and a sensing member, which is symbolized by the capacitive sensor 212, changes, the time constant of the RC circuit 213 changes. The time constant of the RC circuit 213 is the product RC as understood by those skilled in the art. Variation of the time constant of the RC circuit 213 varies the oscillation frequency of the oscillator 216, which varies a frequency count of the frequency counter 218. The frequency of the oscillator is inversely proportional to RC (or proportional to 1/RC). Thus, from the count of the frequency counter 218, the controller 118 can determine the user's selection.

When using the keypad 138, a user creates the capacitance and thus determines the time constant of the RC circuit 213 by touching a key. The controller 118 determines the user's selection by comparing the current frequency of the oscillator 216 with a table showing the correspondence between keys and frequencies as described below. Therefore as will become evident from the discussions below, the user input device 210 may require only two electrical lines, a line coupling a sensing member of the capacitive sensor 212 to the controller 118 and the common or ground line, to transmit all signals from the keypad 138. Therefore, among other advantages, the user input device 210 results in simpler interconnect including for example routing of wires, lower weight, and improved reliability.

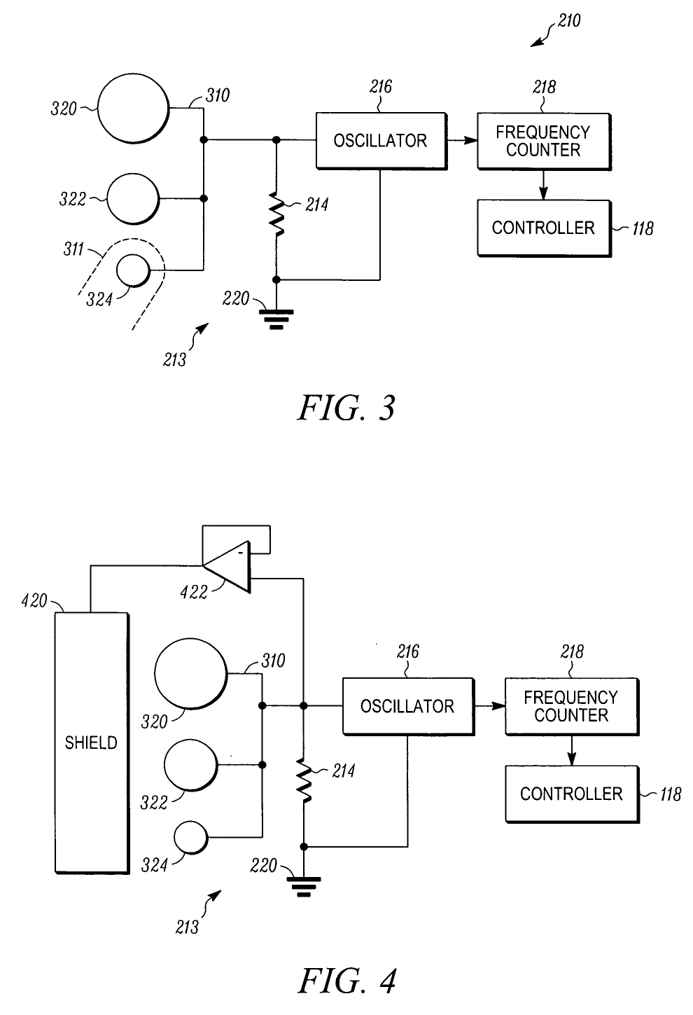

FIG. 3 shows a circuit similar to that of FIG. 2. Specifically, FIG. 3 illustrates details of one embodiment of an apparatus capable of producing the variable capacitance of the RC circuit 213 in cooperation with a user. In particular, the circuit of FIG. 3 includes a sensing member 310. The sensing member 310 of this exemplary embodiment can be, for example, a conductive member having a non-uniform shape, as shown in FIG. 3. The sensing member 310 produces a different capacitance in cooperation with a user depending on the position of a user appendage or body part, e.g. a user's finger 311, user's toe, user elbow, or the like (hereinafter finger). A user makes a selection by positioning a finger 311 in proximity to and over a selected portion of the sensing member 310. The common, or overlapping, area between the sensing member 310 and a user's finger 311 determines the resulting capacitance. Thus, the alignment of the tip of a user's finger 311 with the surface area of a section of the sensing member 310 is important in determining the capacitance produced by the user and the sensing member 310.

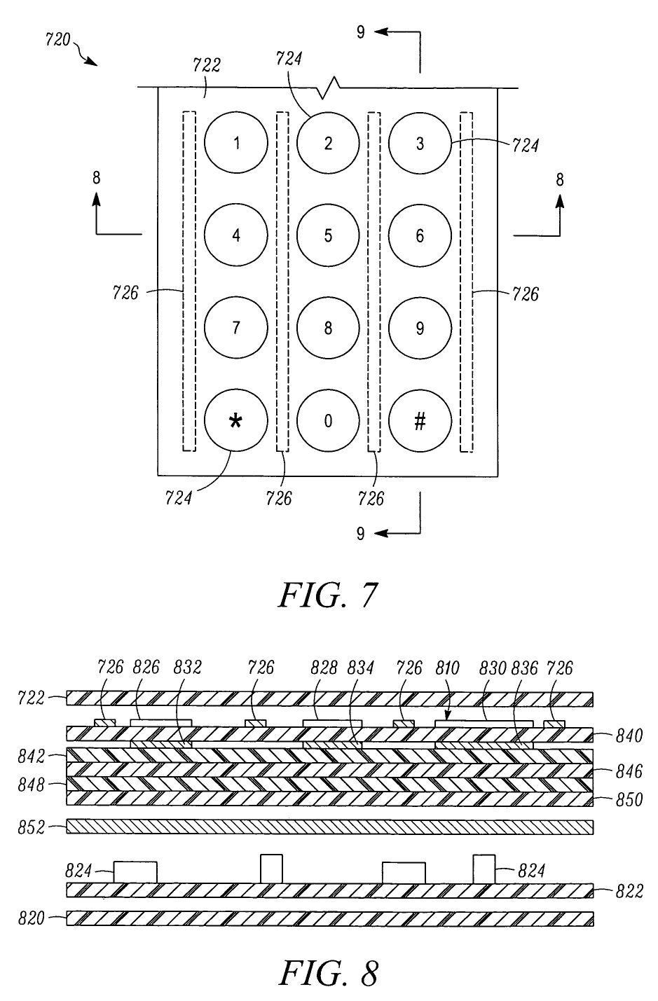

The sensing member 310 includes a plurality of discrete surfaces 320, 322, 324 that can correspond to keys of a keypad. Each of the discrete surfaces 320, 322, 324 is different from the others in capacitive characteristics, e.g. area of the respective surfaces. That is, each produces a different capacitance in the RC circuit 213 when placed in close proximity to the tip of a user's finger 311. In FIG. 3, each of the discrete surfaces 320, 322, 324 differs from the others in area. However, as described below with reference to FIGS. 7-9, the discrete surfaces 320, 322, 324 can have the same area if the capacitance produced by the sensing member 310 is varied in another way. For example, the minimum distance by which a user's finger 311 is separated from the discrete surfaces 320, 322, 324 can be different for each of the discrete surfaces 320, 322, 324. This can be accomplished by placing the discrete surfaces 320, 322, 324 on different planes of a laminated circuit board, for example. This can also be accomplished by placing plastic or a similar material of varying thicknesses over the discrete surfaces 320, 322, 324. Thus, the plastic would limit the distance by which a finger 311 can approach the sensing member 310.

When a user places a finger 311 in close proximity and in a facing relationship to a section of the sensor plate, or to one of the discrete surfaces 320, 322, 324, the user is not only capacitively coupled to one of the discrete surfaces 320, 322, 324 but is also capacitively coupled to the ground area 220. The coupling between the ground area 220 and the user can occur, for example, between a hand that holds the communication device 110 and a chassis of the communication device 110. The coupling between the ground area 220 and the user can also be accomplished by placing a conductive ground member (a metal conductive member coupled to the ground area 220) in close proximity to the user's finger 311 when the user makes a selection. It will be appreciated by those of ordinary skill in the art that the conductive ground member typically should not be placed in a facing relationship with the sensing member 310, since such an arrangement could create a significantly large capacitor between the sensing member and the ground area 220, which would then degrade the performance of the keypad 138. In general, the larger the effective surface area of the ground area 220, the better the performance of the capacitive user input device 210.

When a user makes a selection with the keypad 138, the user is capacitively coupled to the sensing member 310 and to the ground area 220. A first variable capacitance exists between the user's body and the sensing member 310. A second variable capacitance exists between the user's body and the ground area 220. A further unintended, small capacitance, including a parasitic capacitance, is present at the input of the oscillator 216. The capacitance symbolized by the capacitive sensor 212 in FIG. 2 is the net effect of these capacitances, or overall capacitance. The overall capacitance is most affected by the capacitive characteristics of the discrete surface 320, 322, 324 in cooperation with a user's finger when the user selects a corresponding key. Thus, the controller 118 can easily distinguish which key, or discrete surface 320, 322, 324, has been selected based on the time constant of the RC circuit 213, of which the sensing member 310 is a part.

FIG. 4 shows a further embodiment of the user input device of FIGS. 2 and 3 that includes a shield 420. The shield 420 is coupled to the sensing member 310 through a buffer 422. The buffer 422 serves to maintain the shield 420 at the same voltage level as the sensing member 310 and to prevent the shield 420 from affecting the oscillator 216. That is, as seen by the oscillator 216, the buffer 422 is a high impedance device. The purpose of the shield 420 is to shield the sensing member 310 from other electronic parts of the communication device 110. That way, other electronic parts of the communication device 110 will not affect the capacitive characteristics of the sensing member 310. The shield 420 is maintained at the same voltage level as the sensing member 310 to prevent the formation of a capacitance with the sensing member 310 and the shield. Except for the shield 420 and the buffer 422, the embodiment of FIG. 4 is the same as that of FIG. 3.

FIG. 5 is a flowchart illustrating an exemplary routine for determining a user selection 124 with a user input device such as that of FIG. 3 or FIG. 4. At 520 of FIG. 5, the processor 120 monitors the frequency of the oscillator 216. At 522, the processor 120 determines whether the frequency has changed. At 522, the processor 120 can, for example, determine whether a frequency change of a predetermined degree has occurred. If the frequency has changed by a predetermined degree, the processor 120 refers to the table of FIG. 6 to determine which key has been selected by a user based on the current time constant of the RC circuit 213, which is represented by the current frequency of the oscillator 216. That is, the processor 120 determines in which frequency range of FIG. 6 the current frequency falls. Then, the processor 120 determines the corresponding key.

FIG. 6 shows a table of data, which can serve as the keypad data 126 of FIG. 1. In FIG. 6, key A corresponds to the first discrete surface 320, key B corresponds to the second discrete surface 322, and key C corresponds to the third discrete surface 324. Various users will apply varying amounts of pressure to the keys of the keypad 138. The varying finger pressures produce varying capacitances in the capacitive sensor 212. Therefore, the frequency ranges can be used in the table of FIG. 6 to recognize key selections of various users. Furthermore, the frequency ranges can be adjusted to suit a particular user. Note that values corresponding to RC time constants or a range of RC time constants could be stored in the table of FIG. 6 in addition to or instead of the frequency ranges. One of ordinary skill will recognize that these values correspond to each other, i.e. are interchangeable, although some may prefer one over the other from a measurement perspective. The frequency ranges can be set through a learning process performed by software for a particular user. In other words, a software routine for learning frequency ranges 125 that is run by the communication device 110 can request a user to press a certain series of keys on the keypad 138. The software then records the frequencies of the oscillator 216 that result in the memory 122, and the resulting frequencies can be used to create appropriate ranges for the table of FIG. 6.

FIG. 7 shows an exemplary keypad 138 of the communication device 110 in more detail. The keypad 138 can be housed by a plastic housing, which includes an upper housing member 722 and a lower housing member 820 (see FIG. 8). The sides of the housing are not illustrated for the sake of simplicity. A plurality of keys 724 are formed on the upper housing member 722 in a matrix of rows and columns. In this example, the keys 724 are not movable but are merely indicia printed on the surface of the upper housing member 722. However, the keys 724 can be movable and can provide tactile sensations as in conventional keypads.

As shown in FIG. 8, a laminated circuit board is located between the upper and lower housing members 722, 820. The laminated circuit board includes a first layer 840, a second layer 842, a third layer 846, a fourth layer 848, and a fifth layer 850. On the upper surface of the first layer 840, copper traces are shaped to form a first discrete surface 826, a second discrete surface 828, and a third discrete surface 830. The discrete surfaces 826, 828, 830 form part of a sensing member 810, or sensor plate, which corresponds to the sensing member 310 of FIG. 4. The discrete surfaces 826, 828, 830 correspond to the keys 724 labeled one, two and three, respectively, in FIG. 7. In this example, the discrete surfaces 826, 828, 830 are round as in the diagram of FIG. 4. The discrete surfaces 826, 828, 830 are electronically coupled together along with discrete surfaces corresponding to all other keys of the keypad 138 to form the sensing member 810. The discrete surfaces 826, 828, 830 differ from one another in area. Thus, the capacitive characteristics of each of the discrete surfaces 826, 828, 830 differ from one another.

Four conductive ground members 726 are also formed on the surface of the first layer 840, to the sides of and between columns of the keys, with copper traces. The conductive ground members 726 are coupled to the circuit ground area 220 of FIG. 4. As mentioned above, the conductive ground members 726 improve the performance of the keypad 138 by facilitating a coupling between the user and the circuit ground area 220.

On the upper surface of the second layer 842, copper traces are shaped to form a fourth discrete surface 832, a fifth discrete surface 834, and a sixth discrete surface 836 of a second row of keys. The discrete surfaces 832, 834, 836 of the second row of keys along with the discrete surfaces 826, 828, 830 of the first row of keys are electronically coupled together to form part of the sensing member 810, which corresponds to the sensing member 310 of FIG. 4. The discrete surfaces 832, 834, 836 correspond to the keys 724 labeled four, five and six, respectively, in FIG. 7. The discrete surfaces 832, 834, 836 of the second row of keys differ from one another in area. Thus, each of the discrete surfaces 832, 834, 836 differs from the others in capacitive characteristics. However, the discrete surfaces 832, 834, 836 of the second row of keys 724 are on a different plane with respect to the discrete surfaces 826, 828, 830 of the first row of keys 724. Therefore, the distance by which a user's finger 311 is separated from the discrete surfaces 832, 834, 836 of the second row of keys 724 when a user makes a selection is greater than that of the discrete surfaces 826, 828, 830 of the first row of keys 724. In other words, the distance from the discrete surfaces 832, 834, 836 of the second row of keys 724 to the upper surface of the upper housing member 722 is greater than that of the discrete surfaces 826, 828, 830 of the first row of keys 724.

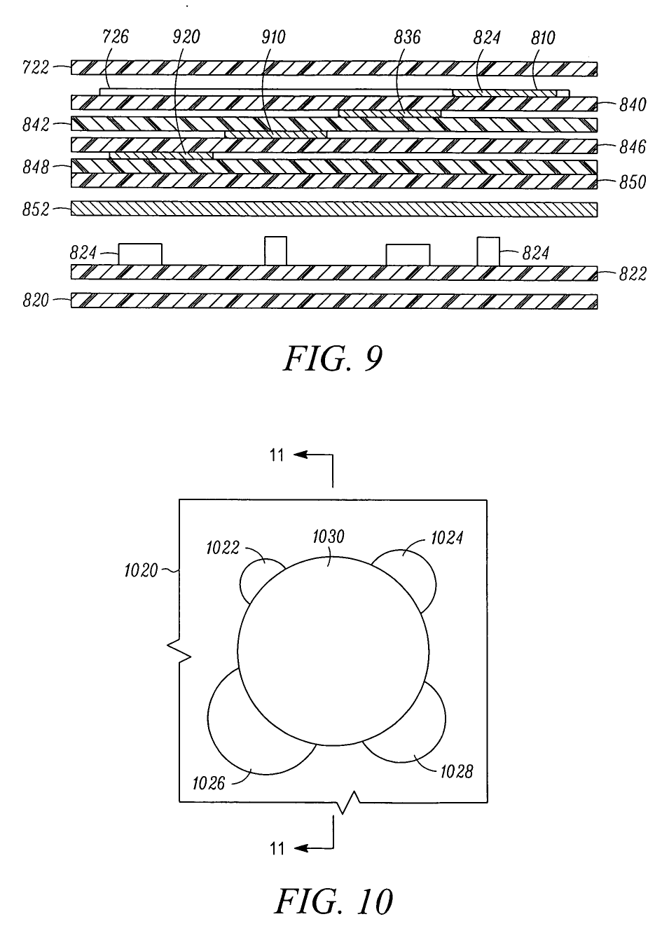

Although not shown fully, discrete surfaces made of copper traces are formed on the third layer 846 for the third row of keys 724. Likewise, discrete surfaces are formed on the fourth layer 848 for the fourth row of keys 724. Each row of discrete surfaces is like that of the first row of keys 724, and all the discrete surfaces of all the rows are coupled together to form the sensing member 810. In the example of FIGS. 7-9, the sensing member 810 has twelve discrete surfaces (eight of which can be seen in FIGS. 8 and 9).

FIG. 9 shows four discrete surfaces 830, 836, 846, 848 of the third column of keys 724. On the first layer 840, the discrete surface 830, which corresponds to the key labeled with a three, is formed. On the second layer 842, the discrete surface 836, which corresponds to the key labeled with a six, is formed. On the third and fourth layers, 846, 848, discrete surfaces 910, 920 that correspond to the keys labeled with a nine and with the pound symbol, respectively, are formed.

In the example of FIGS. 7 and 8, all the discrete surfaces of a given column of keys 724 have the same surface area, and all the discrete surfaces of a given row are located on the same plane. However, the discrete surfaces of a given row have different surface areas, and the discrete surfaces of a given column are each on different planes. Therefore, no two discrete surfaces have the same combination of surface area and elevation. Therefore, each of the discrete surfaces has unique capacitive characteristics in the keypad 138 in cooperation with a user's finger. Therefore, the selection of a key 724 produces a distinct range of frequencies in the oscillator 216 of FIG. 4, and the controller 118 can therefore determine which key 724 has been selected by a user.

FIGS. 8 and 9 also show a chassis 822 of the communication device 110, which, in the illustrated embodiment, is located between the lower housing member 820 and the fifth layer 850. Various electrical components 824 are located on the chassis 822. A shield 852 is located between the chassis 822 and the circuit board layers 840, 842, 846, 848 on which the sensing member of the keypad 138 is formed. The shield 852 corresponds to the shield 420 of FIG. 4. Thus, the shield 852 is electrically coupled to the sensing member 810, or sensor plate, formed by the discrete surfaces of FIGS. 8 and 9, like the shield 420 shown schematically in FIG. 4. The shield 852 can be a copper layer formed on the lower surface of the fifth layer 850 or it can be a separate metal member, for example.

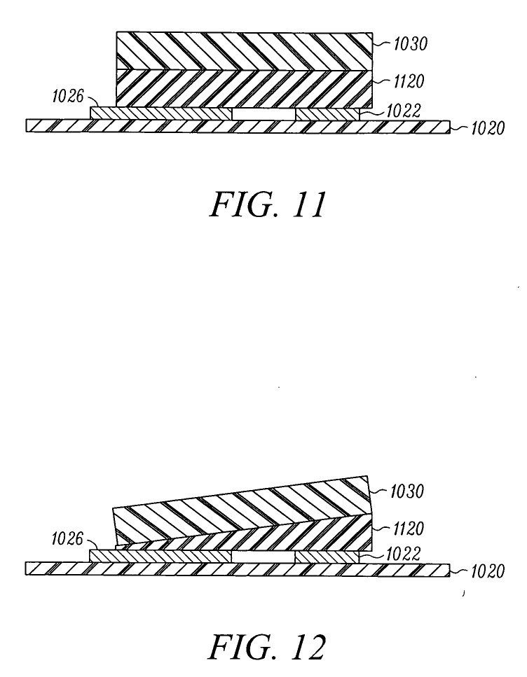

FIGS. 10-12 show a further embodiment of the user interface. FIG. 10 shows a directional button 1030 which operates like a joy stick. A sensing member, which corresponds to the sensing member 310 of FIG. 4, is formed by a first discrete surface 1022, a second discrete surface 1024, a third discrete surface 1028 and a fourth discrete surface 1026. The discrete surfaces 1022, 1024, 1028, 1026 form a sensing member, which is part of an RC circuit 213 like the discrete surfaces 320, 322, 324 of FIG. 3. The discrete surfaces 1022, 1024, 1028, 1026 can be copper traces formed on a circuit board 1020 and are electrically coupled together. The discrete surfaces 1022, 1024, 1028, 1026 are arranged in a circular pattern as shown. The directional button 1030 is fixed to a flexible member 1120, which is made of rubber, rubber foam, or similar flexible or compressible material, above the discrete surfaces 1022, 1024, 1028, 1026. The flexible member 1120 is attached to the circuit board 1020 as shown. The flexible member 1120 is compressible such that a user's finger can tilt the directional button 1030 in any direction. When a user tilts the directional button 1030, the user's finger alters the capacitance of the RC circuit 213 that includes the discrete surfaces 1022, 1024, 1028, 1026. Thus, the discrete surfaces 1022, 1024, 1028, 1026 and the user form a sensor, which is symbolized by the capacitive sensor 212 of FIG. 2. Since each of the discrete surfaces 1022, 1024, 1028, 1026 has a different area, the time constant of the RC circuit 213 that includes the discrete surfaces 1022, 1024, 1028, 1026 will differ according to the direction in which the directional button 1030 is tilted. Therefore, the controller 118 can determine the direction in which the directional 1030 button has been tilted based on the frequency of the oscillator 216. Similarly, the controller 118 can determine if the directional button 1030 has been pressed straight down and not tilted in any direction based on the time constant of the RC circuit 213, of which the discrete surfaces 1022, 1024, 1028, 1026 form a part. Therefore, the directional sensor of FIGS. 10-12 can form a four-way or a five-way switch.

FIGS. 13-17 show various directional sensors, which can be formed by non-uniform sensing members. That is, the sensing members can have varying cross-sections, as shown. The sensing members of FIGS. 13-17 are normally covered with a plastic housing member. Thus, a user's fingertip is normally separated from and in a facing relationship to the sensing members. FIG. 13 shows a directional sensor, which includes a sensing member 1326 made, for example, of metal on a circuit board 1320. The sensing member 1326 corresponds to the sensing member 310 of FIG. 3. Thus, although not illustrated in FIG. 13, the sensing member 1326 forms part of an RC circuit, like that shown in FIG. 3. The time constant of the RC circuit changes as the amount of area that is common between a user's finger and the sensing member 1326 changes as a user's finger moves along the sensing member 1326. Thus, the controller 118 can determine whether a user's finger is moving toward the wide end or toward the narrow end of the sensing member 1326. A user can swipe along the sensing member 1326 with a hand or finger, and the controller 118 can determine the direction of the swipe based on whether the frequency of the oscillator 216 increases or decreases. Thus, a user can use an interface that employs the sensing member 1326 to indicate direction.

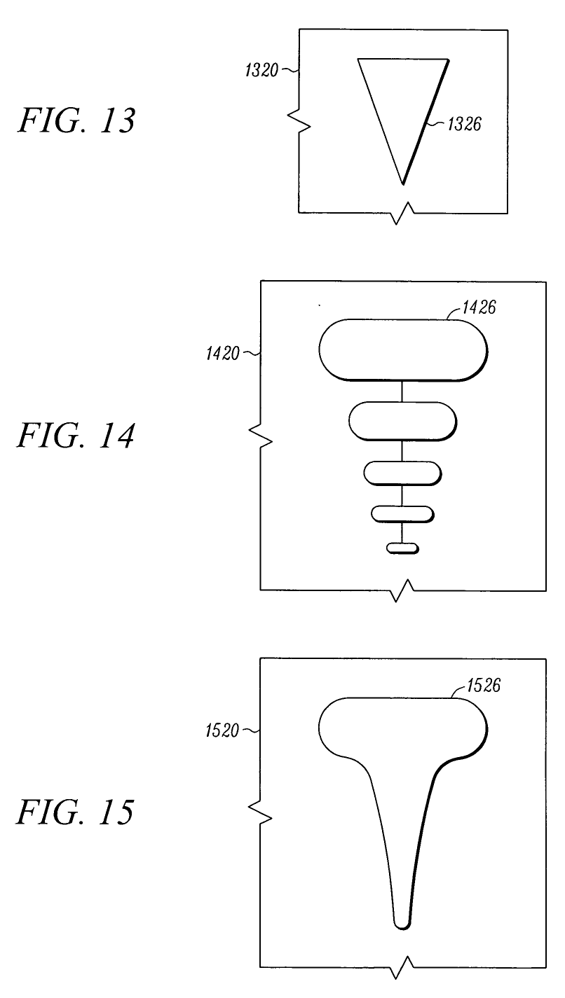

FIG. 14 shows a sensing member 1426, which is a metal member formed on a circuit board 1420. The sensing member 1426 has discrete surfaces of different areas, like the sensing member 310 of FIG. 3. The capacitive characteristics of the sensing member 1426 vary according to the position of a user's finger when a user's finger is in close proximity to the sensing member 1426, due to the change in area of the variable capacity member 1426 that is overlapped by a user's fingertip. Thus, when the sensing member 1426 forms part of a variable capacity capacitor like that shown in FIG. 2, the controller 118 can determine the direction of a user's finger motion and can thus determine the direction of a user's selection.

FIG. 15 shows a metal sensing member 1526 formed on a circuit board 1520. The sensing member 1526 operates in the same manner as that of FIG. 13. However, unlike the sensing member 1326 of FIG. 13, the taper of the sensing member 1526 is not uniform.

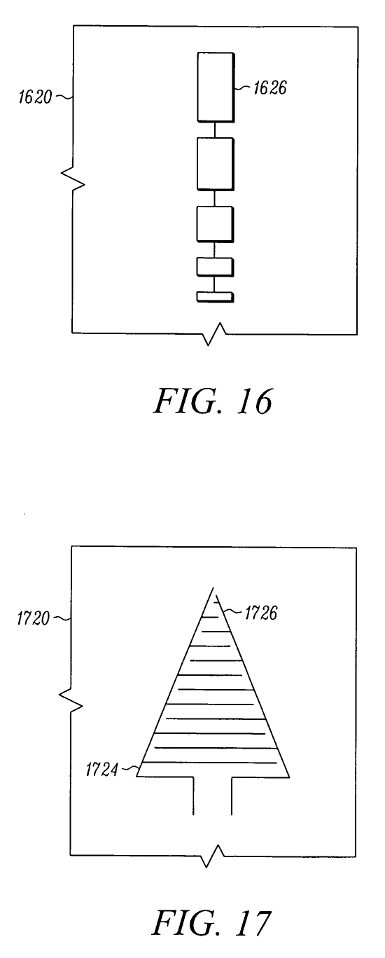

FIG. 16 shows a metal sensing member 1626 formed on a circuit board 1620. The sensing member 1626 operates in the same manner as the sensing member 1426 of FIG. 14. However, the areas of discrete surfaces of the sensing member 1626 are varied by changing their longitudinal dimensions. Each of the discrete surfaces results in different capacitive characteristics when faced in close proximity by a user's fingertip.

FIG. 17 shows a directional sensor which includes two types of metal traces on a circuit board 1720. A first metal trace forms a sensing member 1726, which corresponds to the sensing member 310 of FIG. 3. A second metal trace forms a conductive ground member 1724, which is coupled to the ground area 220 of the circuit of FIG. 3. Thus, the conductive ground member 1724 corresponds to the ground member 726 of FIG. 8 and serves to capacitively couple the user to the circuit ground area 220. The capacitive characteristics of the sensing member 1726 vary according to the position of a user's finger. Thus, when the sensing member 1726 forms part of a variable capacity capacitor like that of FIG. 2, the controller 118 can determine the direction of a finger swipe, for example.

The apparatus and methods discussed above and the inventive principles thereof are intended to and will alleviate problems with conventional user interfaces and with conventional electronic devices. Using these principles will contribute to user satisfaction by, for example, reducing costs and complexities associated with a user interface. It is expected that one of ordinary skill given the above described principles, concepts and examples will be able to implement other alternative procedures and constructions that offer the same benefits. It is anticipated that the claims below cover many such other examples. For example, the shapes and locations of the discrete surfaces 320, 322, 324 can be varied infinitely, as long as varying capacitances can be produced to permit the controller to distinguish among all possible selections.

The disclosure is intended to explain how to fashion and use various embodiments in accordance with the invention rather than to limit the true, intended and fair scope and spirit thereof. The forgoing description is not intended to be exhaustive or to limit the invention to the precise form disclosed. Modifications or variations are possible in light of the above teachings. The embodiments were chosen and described to illustrate the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

1. A user interface for an electronic device comprising:
a capacitive circuit, wherein:
the capacitive circuit is formed in part by a sensing member, wherein the sensing member produces varying capacitive characteristics in cooperation with a user's body part depending on a position of the user's body part with respect to the sensing member;
a user makes a selection by positioning a body part in proximity to a selected portion of the sensing member; and
a time constant of the capacitive circuit corresponds to the selection; and
a controller configured to determine the selection based on the time constant of the capacitive circuit.

2. The user interface according to claim 1, wherein an oscillator is coupled to the controller and a frequency of the oscillator is dependent on the time constant.

3. The user interface according to claim 2, wherein the controller includes a processor and a memory, and the memory is coupled to the processor, and wherein the memory stores at least one of a range of frequencies and a range of time constants corresponding to each of various portions of the sensing member.

4. The user interface according to claim 1, wherein the sensing member includes a plurality of discrete surfaces that correspond to keys of a keypad, wherein each of the discrete surfaces is different from the others in capacitive characteristics.

5. The user interface according to claim 4, wherein each of the discrete surfaces differs from the others in area.

6. The user interface according to claim 4, wherein each of the discrete surfaces is located in a different plane of a laminated circuit board.

7. The user interface according to claim 1 further comprising a frequency counter coupled to the oscillator, wherein the frequency counter is coupled to the controller, and the controller determines which part of the sensing member has been selected by the user according to information provided by the frequency counter.

8. The user interface according to claim 1, wherein the sensing member includes at least two discrete sections, which differ from one another in capacitive characteristics and which are arranged in a generally circular pattern to form a directional user input device.

9. The user interface according to claim 8, wherein a movable member is located over the discrete sections, such that manipulation of the movable member by a user's hand changes the time constant of the capacitive circuit.

10. A user interface for an electronic device comprising:
an RC (Resistor Capacitor) circuit, further comprising a sensing member that forms a part of a capacitor of the RC circuit and varies in capacitive characteristics in cooperation with a position of a user's finger, the sensing member producing a different capacitance, the different capacitance depending on the capacitive characteristics of a portion of the sensing member that faces the user's finger when a user makes a selection by positioning a finger in proximity to a selected portion of the sensing member; and
a controller configured to provide a means to detect a characteristic corresponding to the RC circuit and configured to provide a means to determine the selection based on the characteristic corresponding to the RC circuit.

11. The user interface according to claim 10, wherein the characteristic corresponds to a time constant of the RC circuit, and the user interface further comprises an oscillator having a frequency which is dependent on the RC circuit, wherein the controller determines the selection according to the frequency of the oscillator.

12. The user interface according to claim 11, wherein the controller includes a processor and a memory, the memory being coupled to the processor and configured to store a range of frequencies corresponding to each of various portions of the sensing member.

13. The user interface according to claim 10, wherein the sensing member includes a plurality of discrete surfaces that correspond to keys of a keypad.

14. The user interface according to claim 13, wherein each of the discrete surfaces differs from the others in area.

15. The user interface according to claim 13, wherein each of the discrete surfaces is located to differ from the other discrete members in a minimum separation distance from the user's finger.

16. The user interface according to claim 10, wherein the sensing member includes at least four discrete sections, which differ from one another in capacitive characteristics and which are arranged in a generally circular pattern to form a directional user input device.

17. The user interface according to claim 16, wherein a movable member is located over the discrete sections, such that manipulation of the movable member by the user's finger changes the capacitance produced by the sensing member and the user's finger.

18. A method of determining a selection made by a user of a user interface, wherein the method comprises:
providing a sensing member, which forms part of a capacitive circuit, wherein a user's finger determines the capacitance of the capacitive circuit according to physical characteristics of a portion of the sensing member that is in a facing relationship to the user's finger;
measuring a characteristic corresponding to the capacitive circuit;
determining the user's selection based on the characteristic of the capacitive circuit.

19. The method according to claim 18 including forming the sensing member to have discrete sections, the discrete sections in cooperation with a user's finger differing from one another in capacitive characteristics.

20. The method according to claim 19 including arranging the discrete sections in a generally circular pattern to form a directional user input device.
